(19) United States
(12) Patent Application Publication
(10) Pub. No.: US 2018/0089604 A1
(43) Pub. Date: Mar. 29, 2018

(54) REAL-TIME SUPPLY RESPONSE PLANNING

(71) Applicant: SAP SE, WALLDORF (DE)

(72) Inventors: NADINE GAERTNER, SPEYER (DE); OLGERT LINDAU, HEIDELBERG (DE); THOMAS SCHULZ, SPEYER (DE)

(21) Appl. No.: 15/278,467

(22) Filed: Sep. 28, 2016

(51) Int. Cl. G06Q 10/06; G06F 17/30

(52) U.S. Cl. CPC G06Q 10/06312; G06F 17/30339

(57) ABSTRACT

Described are system, method, and computer program product embodiments for performing real-time supply chain response planning. Described embodiments operate by receiving, from a client device, a request that specifies a quantity of a product requested by a deadline. Then, a list of constraint variants associated with the product is identified from a constraint variants table. Each constraint variant in the list is associated with a net-availability table stored in a column-store in-memory database. Based on the constraint variants table, a required capacity for each constraint variant in the list to satisfy the request is determined. To determine whether the required capacity is satisfied for each constraint variant, the request is simulated within a current supply chain plan by aggregating an available capacity for each constraint variant using one or more columns of the associated net-availability table. Based on the simulated request, a result is sent to the client device.

### BACKGROUND

Supply response planning systems are used to manage customer sales, related operations, demand, inventory, supply, and response planning. Conventional response planning systems are capable of performing a full planning run and a simulation run. During a full planning run, a response planning system creates a supply chain plan to satisfy a plurality of requests, e.g., sales orders or primary demands. The created supply chain plan often includes many, e.g., thousands, of scheduled requests. The response planning system is also capable of performing a simulation run, which simulates a small number of new requests, e.g., one request, within a current supply plan without having to re-schedule all the requests within the supply chain plan. The current supply plan may be a supply chain plan created during the previous full planning run.

During a simulation run, however, conventional response planning systems use a created supply chain plan to generate an object model for simulating a new request. Not only do conventional response planning systems need additional processing time to convert data stored in the current supply chain plan into the object model, but also operating on the created objects to simulate the new request is complicated and slow. Therefore, these response planning systems cannot provide real-time, e.g., sub-second, supply response planning.

### BRIEF DESCRIPTION OF THE DRAWINGS

The accompanying drawings are incorporated herein and form a part of the specification.

FIG. 1 is a block diagram of a database system for implementing real-time supply chain response planning, according to embodiments of the disclosure.

FIG. 2 is a diagram illustrating how an ordered list of constraint variants is selected for a product, according to embodiments of the disclosure.

FIGS. 3A-B are diagrams illustrating how to simulate a request within a supply planning run, according to embodiments of the disclosure.

FIG. 4 is a table illustrating fields that enable real-time supply chain response planning, according to embodiments of the disclosure.

FIG. 5 is a flow chart illustrating a process to provide real-time supply chain response planning, according to embodiments of the disclosure.

FIG. 6 is a flow chart illustrating a process for providing more accurate real-time supply chain response planning, according to embodiments of the disclosure.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for providing real-time supply chain response planning. In an embodiment, a response planning engine receives, from a client, a request that specifies a quantity of a product requested by a deadline. The request is to be scheduled within a current supply chain plan representing a plurality of scheduled requests. The response planning engine then identifies, from a constraint variants table, a list of constraint variants associated with the product, where each constraint variant in the list is associated with a net-availability table stored in a column-store in-memory database. Based on the constraint variants table, the response planning engine determines a required capacity for each constraint variant in the list to satisfy the request. To determine whether the required capacity is satisfied for each constraint variant, the response planning engine simulates the request within the current supply chain plan by aggregating an available capacity for each constraint variant using one or more columns of the associated net-availability table. Then, the response planning engine sends, to the client, a result indicating whether the request can be successfully scheduled based on the simulated request.

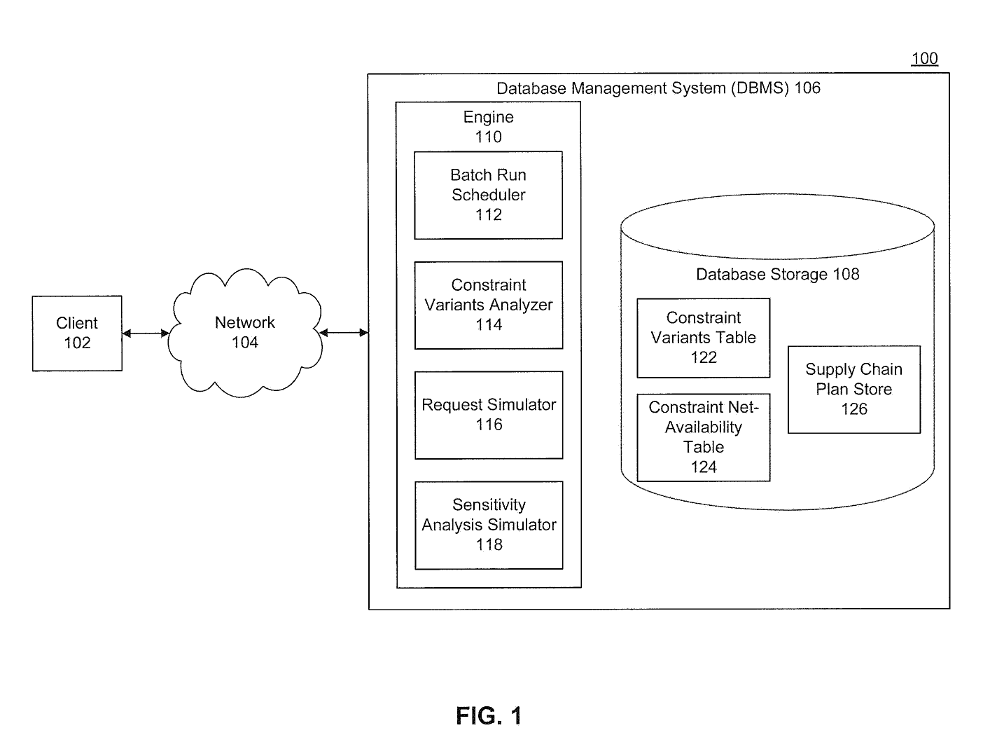

FIG. 1 is a block diagram of a database system 100 for implementing real-time supply chain response planning, according to various embodiments. System 100 includes client 102, network 104, and database management system (DBMS) 106. DBMS 106 includes engine 110 and database storage 108. Client 102 communicates with DBMS 106 over network 104. Network 104 may be, for example, a LAN (Local Area network), MAN (metropolitan area network), WAN (Wide Area Network) such as the Internet, or any combination thereof. Network 104 may further utilize Ethernet communications, although other wired and/or wireless communication techniques, protocols, and technologies can be used.

Client 102 may be a computing device capable of connecting to network 104. For example, a computing device may be a laptop, a desktop computer, or a mobile device (e.g., a mobile phone). Client 102 may be operated by a user to access an application, e.g., via the Internet, for communicating with DBMS 106. In an embodiment, client 102 communicates a request to DBMS 106, which then simulates the request within a current supply chain plan. After running the simulation, DBMS 106 may communicate the results of the simulation to client 102. The results may include, for instance, information indicating whether the request can be successfully scheduled within a current supply chain plan. This communication can then be communicated to a user of client 102 via, for instance, a user interface. For example, the user may be a sales representative that is trying to fulfill a customer's sales order. Upon receiving the sales order, the user may submit the sales order via client 102 as a request for a quantity of a product required by a deadline. This request may then be simulated by DBMS 106.

According to various embodiments, database storage 108 may be implemented as one or more in-memory databases, disk storage devices, or a combination thereof. Further, database storage 108 may be implemented as distributed databases or memories. Data stored in database storage 108 can be logically organized in the form of tables with each table having a number of rows (i.e., records) and columns (i.e., fields). Each row in a table generally has a data value associated with each column of the table. This intersection between one row and one column is commonly referred to as a cell.

According to embodiments, to improve the speed of database queries and to enable real-time supply response planning, database storage 108 implements one or more column-store (or column-oriented) in-memory databases. In contrast to conventional databases, a column-store database stores tables as columns rather than as rows. In such embodiments, due to the columnar storage of data, database queries that operate on one or more columns in the table can be performed near real-time or in real-time.

As shown, database storage 108 includes constraint variants table 122, constraint net-availability table 124, and supply chain plan store 126, each of which may be implemented within a column-store database. Supply chain plan store 126 represents one or more supply chain plans that were created during previous full-planning runs. As described above, during a full-planning run, DBMS 106 generates a supply chain plan to satisfy a plurality of requests. In the context of supply chain planning, a request may include a demand for a product and associated parameters. For example, parameters may include a deadline for the requested demand or one or more desired characteristics for the product. In an embodiment, the supply chain plan includes various aspects for satisfying the requests from, e.g., the suppliers of materials/parts of the product, the assemblers of the materials/parts, to logistics providers.

Constraint variants table 122 stores associations between a product (specified in a request) and one or more constraint variants. A constraint variant is a specific constraint that must be satisfied to satisfy the request for the product. For example, the constraint variant may be related to a transportation resource, a components supplier, a production plant, or other resources needed to generate the product. In an embodiment, DBMS 106 selects a list of constraint variants, with each constraint variant selected from possible variants, to associate with each product. In an embodiment, the list is an ordered list of constraint variants. Constraint variants table 122 may store information associated with each constraint variant. For example, this information may include a price per unit of the constraint variant, a required time to produce/generate a unit of the constraint, or a relationship with other constraint variants in the list of constraint variants.

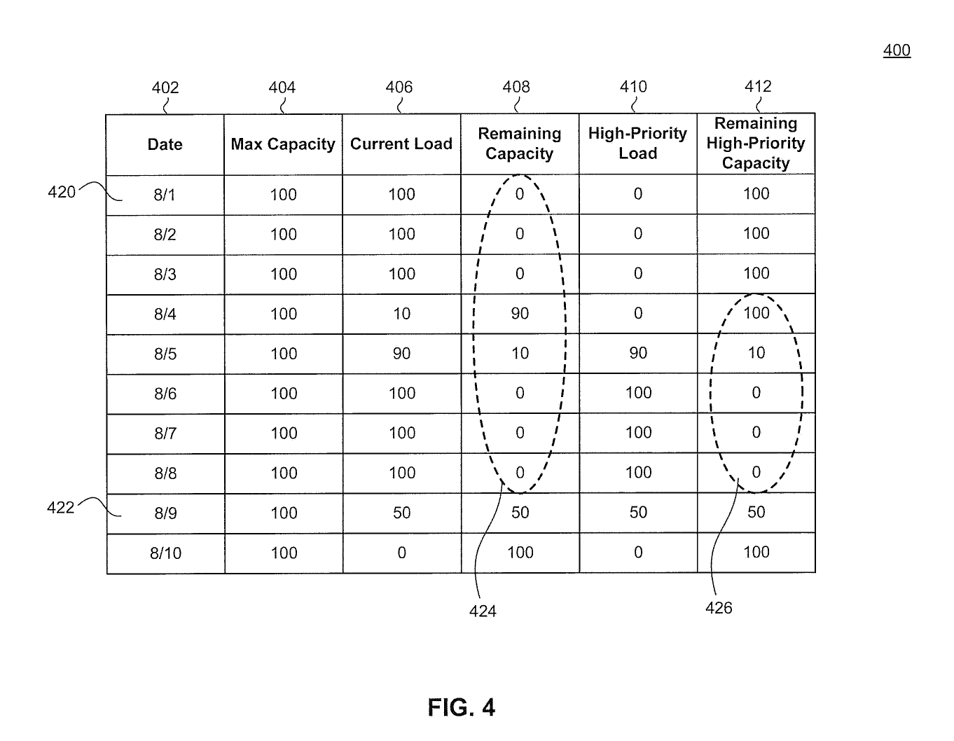

Constraint net-availability table 124 stores, for each constraint variant, key performance indicators (KPIs) related to an availability of the constraint variant at an instance of time. For example, as further described with respect to FIG. 4, constraint net-availability table 124 for a constraint variant may include a maximum capacity or a current load (among other KPIs) of the constraint variant on a day-to-day basis.

To access data within the tables of database storage 108, DBMS 106 processes commands in the form of queries. A query may be specified in a database manipulation language, such as Structured Query Language (SQL). SQL is well known and is described in many publicly available documents, including “Information Technology—Database languages—SQL,” published by the American National Standards Institute as American National Standard ANSI/ISO/IEC 9075: 1992. Although the following embodiments may be described with respect to SQL query statements, a skilled artisan would recognize that described embodiments are not so limited and are equally applicable to query statements specified in other database manipulation languages.

According to embodiments, to provide real-time supply response planning, DBMS 106 includes engine 110. Engine 110 may include the following components: batch run scheduler 112, constraint variants analyzer 114, request simulator 116, and sensitivity analysis simulator 118. A component of engine 110 may include a selection of stored operations that when executing in one or more processors of DBMS 106 causes the one or more processors to perform the operations of that component.

Batch-run scheduler 112 performs full-planning runs. During a full-planning run, batch-run scheduler 112 creates a supply chain to satisfy a plurality of unscheduled requests. As described above, the supply chain plan may include planned operations of many entities to satisfy each unscheduled request. For example, an unscheduled request may be to produce 100 laptops within 30 days. In this example, the supply chain plan may include a process flow from manufacturers of central processing units (CPUs) and memory chips to a parts assembler, product transporters, and distribution providers. In an embodiment, batch-run scheduler 112 updates the supply chain plan on request, periodically, or when the number of unscheduled requests exceeds a certain number. In an embodiment, one or more supply chain plans generated during previous full-planning runs are stored as supply chain plan store 126. In an embodiment, a current supply chain plan is represented by a plurality of constraint net-availability tables 124 because one constraint net-availability table 124 includes current load information for an associated constraint variant. Therefore, a plurality of constraint net-availability tables 124 indicates the currently scheduled loads for various constraint variants.

Constraint variants analyzer 114 analyzes supply chain plan store 126, representing results of one or more previous full-planning runs, to determine constraint variants associated with each product. In embodiments, constraint variants analyzer 114 may be configured to collect the constraint variants from supply chain plan store 126 related to the product to determine a plurality of ordered lists of constraint variants. Each ordered list of constraint variants may represent a sequence of variants with respective constraints that when met will satisfy a request for the product. Additionally, in various embodiments, constraint variants analyzer 114 may be further configured to aggregate a usage number of each constraint variant within the supply chain plan store 126 to determine the most-commonly-used, e.g., having the highest usage numbers, constraint variants. Then, constraint variants analyzer 114 stores an ordered list of variants, selected from the plurality of ordered lists, having most-commonly-used constraint variants into constraint net-availability table 124. By pre-selecting an ordered list of commonly-used constraint variants to associate with a product, constraint variants analyzer 114 allows engine 110 to provide real-time simulation with minimal effect on simulation accuracy.

Request simulator 116 performs simulation runs. In various embodiments, request simulator 116 is configured to receive, from client 102, a request for a product. As described above, the request may include parameters or characteristics associated with the product to be produced by a deadline. For example, the request may specify that the product include a specific component or that the product be delivered using a specific type of transportation, etc. During a simulation run, request simulator 116 simulates the new received request within a current supply chain plan to determine whether the received request can be successfully scheduled within the supply chain plan. Based on the simulation result, request simulator 116 notifies client 102 of confirmation that the new request can be scheduled or that the new request cannot be successfully scheduled in the current supply chain plan. In an embodiment, request simulator 116 partially confirms the received request. For example, request simulator 116 may confirm a proportion of the desired units of the product.

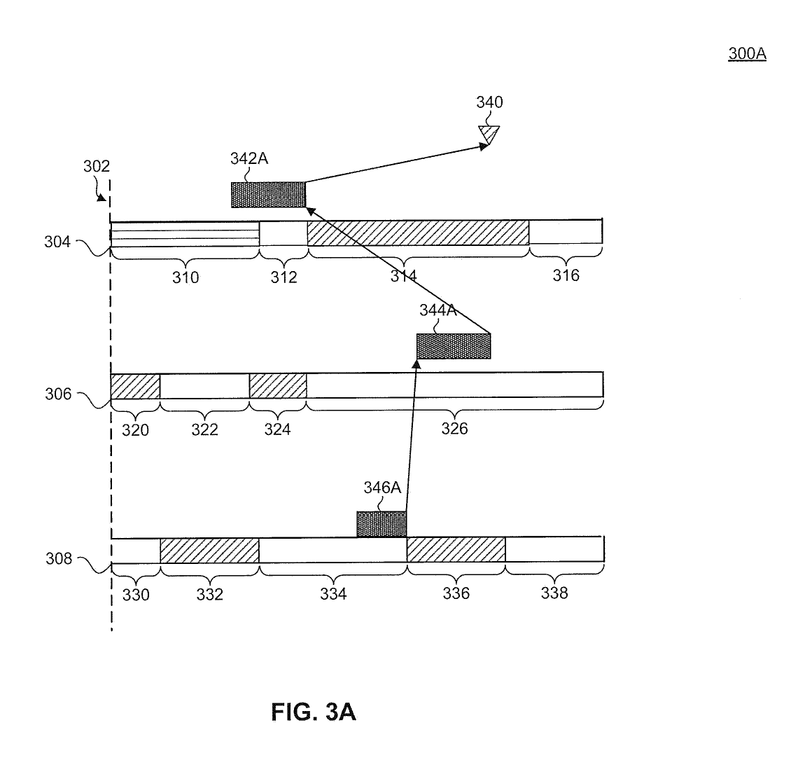

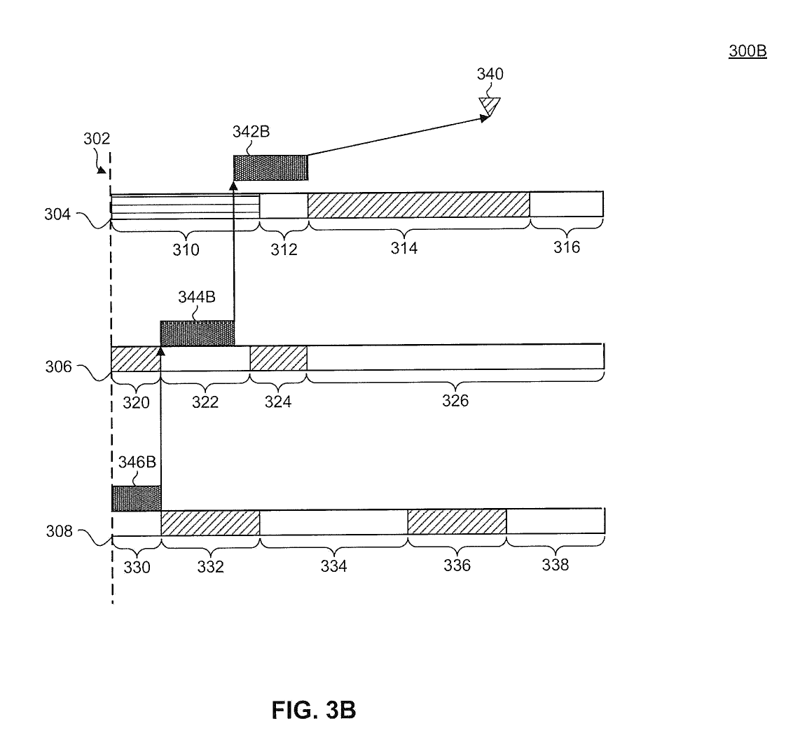

Additionally, as further described with respect to FIGS. 3-4, request simulator 116 may provide real-time supply response planning by querying constraint variants table 122 and constraint net-availability table 124. In these embodiments, request simulator 116 first queries constraint variants table 122 for an ordered list of constraint variants associated with the product indicated in the received request. In an embodiment, request simulator 116 also queries constraint variants table 122 for constraints (e.g., lead time) associated with each of the constraint variants in the ordered list. In an embodiment, based on the queried constraints, request simulator 116 determines a required capacity for each constraint variant in the ordered list to satisfy the received request.

According to various embodiments, for each constraint variant in the list, request simulator 116 queries an associated constraint net-availability table 124 to aggregate an available capacity from a current time to the deadline specified in the request. Additionally, request simulator 116 may aggregate availability capacities of the constraint variants in parallel. If any aggregated capacity is below the associated required capacity, request simulator 116 sends a notification to client 102 that the request cannot be satisfied. In an embodiment, request simulator 116 serially aggregates available capacities from one end of the ordered list to the other end. For example, request simulator 116 may first aggregate an available capacity of a first constraint variant having no children constraint variants. Similarly, the last constraint variant whose available capacity is aggregated by request simulator 116 may be a constraint variant having no parent constraint variants. In an embodiment, by querying constraint net-availability table 124 that is column-oriented, request simulator 116 provides real-time, sub-second simulations of received requests.

Sensitivity analysis simulator 118 performs sensitivity analysis on a current supply chain plan. According to embodiments, a sensitivity analysis includes a plurality of simulation runs that varies one or more parameters of a request. For example, sensitivity analysis simulator 118 may initiate a plurality of simulation runs to schedule a product of various amounts, having various deadlines, or with one or more different parameters, within the current supply chain plan. Then, sensitivity analysis simulator 118 presents confirmation results for each of the simulation runs to client 102.

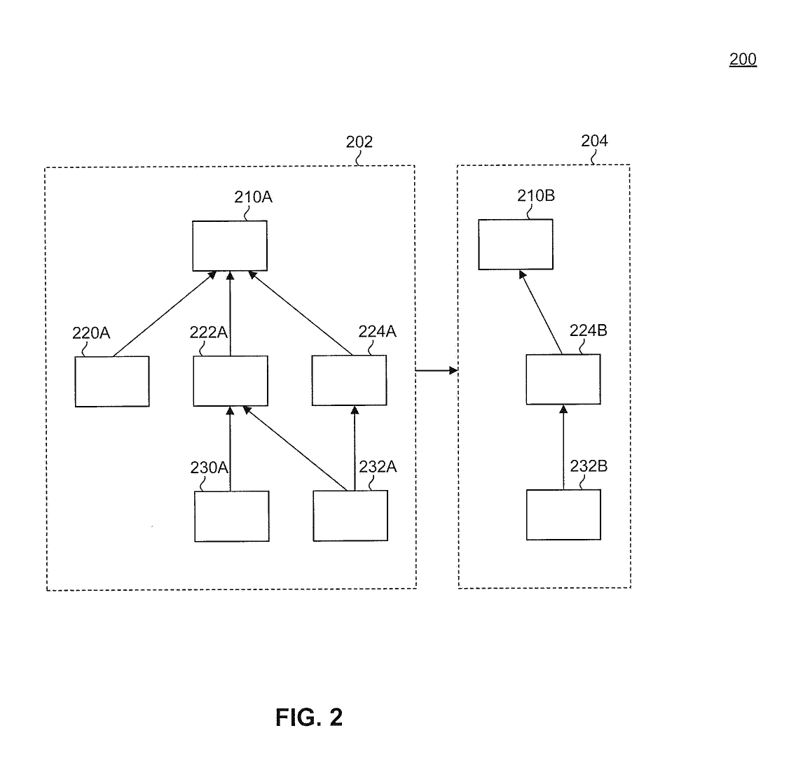

FIG. 2 is a diagram 200 illustrating how a sequence of constraint variants 204 is selected for a product, according to an example embodiment. In an embodiment, constraint variants analyzer 114 from FIG. 1 queries supply chain plan store 126, representative of results of previous full planning runs, to determine constraint variants 202 associated with generating a product. In an embodiment, constraint variants analyzer 114 generates a data structure, e.g., a tree structure or linked lists, as shown in constraint variants 202 that represent various sequences of constraint variants that each result in the product.

For example, constraint variants 230-232 may represent different part suppliers that supply the same part used to generate the product. Constraint variants 222-224 may represent different assembly plants that assemble the parts supplied by part suppliers represented as constraint variants 230-232. Constraint variant 220 may represent a production plant that both produces required parts of the product and assembles those parts to generate the product. Constraint variant 210 may represent a distribution resource, e.g., a distribution center to distribute the final product as produced by one of the assembly or production plants represented by constraint variants 220-224. As indicated by the arrows showing the process flow within constraint variants 202, based on the queried supply chain plan store 126, there exists four possible sequences of constraint variants that result in the product.

In an embodiment, constraint variants analyzer 114 statistically analyzes the queried supply chain plan store 126 to select a sequence of constraint variants 204 having the most-commonly-used constraint variants. In an embodiment, this sequence of constraint variants 204 has the highest number of usage compared to other constraint variant sequences, e.g., the sequence including constraint variants 232A, 222A, and 210A as shown in constraint variants 202. In an embodiment, constraint variants analyzer 114 calculates a usage metric that is a function of the usage numbers of each of the constraint variants within the ordered lists. In an embodiment, constraint variants analyzer 114 saves the selected sequence as an ordered list into constraint variants table 122. Constraint variants analyzer 114 also saves constraints information of each constraint variant within constraint variants table 122.

FIGS. 3A-B are diagrams 300A-B illustrating how to simulate a request within a current supply chain plan, according to example embodiments. In an embodiment, request simulator 116 simulates the request, during a simulation run, according to the mechanism shown with respect to diagrams 300A-300B. As described above, the request may include a demand for a quantity of a product by a deadline. In an embodiment, the request further includes desired characteristics or parameters of the product.

In general, diagrams 300A-B each comprise constraint bars 304-308 depicting currently scheduled loads associated with various constraint variants (e.g., constraint variants 204 depicted in FIG. 2) since a current time 302. For instance, in FIG. 3A, if constraint bar 304 is associated with constraint variant 210B, then it might depict future times when a distribution resource is engaged and available. For instance, constraint bar 304 indicates that a constraint variant (e.g., 210B) is engaged during segments 310 and 314 and free during segments 312 and 316.

In an embodiment, in response to receiving the request from a client device, request simulator 116 queries constraint variants table 122 to retrieve an ordered list of constraint variants that when individually satisfied will satisfy the request. In an embodiment, the ordered list includes constraint variants 232B, 224B, and 210B, which are represented as constraint bars 308, 306, and 304, respectively. In an embodiment, request simulator 116 queries constraint net-availability table 124 associated with each of constraint variants 232B, 224B, and 210B to determine a current load, maximum capacity, remaining capacity, among other constraint information as further described with respect to FIG. 4.For example, constraint bar 304, which may represent constraint variant 210B, has available capacity during the time slots designated by empty segments 312 and 316. But, constraint variant 210B has current loads, i.e., is not available, during the time slots designated by loaded segments 310 and 314. In an embodiment, the type of load of constraint variant 210B may be separated into different priorities. For example, loaded segments 310 and 314 may be designated as high-priority loaded segment 314 and low-priority loaded segment 310. In an embodiment, when the request is associated with a high priority, constraint variants, such as constraint variant 210B, may be available for use during both empty segments and low-priority segments.

Likewise, constraint bar 306, which may represent constraint variant 224B, includes loaded segments 320 and 324 and empty segments 322 and 326. In this example, both loaded segments 320 and 324 are high-priority loads. Constraint bar 308, which may represent constraint variant 232B, includes loaded segments 332 and 336 and empty segments 330, 334, and 338.

In an embodiment, request simulator 116 queries constraint variants table 122 for constraint information to determine a required capacity of each of the constraint variants that must be individually satisfied to satisfy the request. For example, on a current date of August 1^{st} as represented by current time 302, a received request 340 may include a demand for 100 laptops by August 9^{th}. In this example, request simulator 116 may retrieve an ordered list of constraint variants including constraint variants 232B, 224B, and 210B, representing part supplier, assembly plant, and distribution center, respectively. To satisfy the request of 100 laptops by the deadline of August 9^{th}, request simulator 116 may query constraint variants table 122 to determine that 110 units of constraint variant 210B, 110 units of constraint variant 224B, and 50 units of constraint variant 232B are required. This information is represented as demand segments 342A, 344A, and 346A, respectively representing the required capacity for constraint variants 210B, 224B, and 232B.

In an embodiment, request simulator 116 simulates the request by fitting demand segments 342A, 344A, and 346A within the empty segments of constraint bars 304, 306, and 308 respectively. In an embodiment, request simulator 116 accumulates the available capacity, represented by the empty segments, from the deadline August 9^{th} of request 340 to current time 302, e.g., August 1^{st}, for each of constraint bars 304-308. In an embodiment, request simulator 116 accumulates the empty segments for each of the constraint variants in parallel. In this embodiment, request simulator 116 determines that a portion of empty segment 326 and a portion of empty segment 334 satisfy the required capacities represented by demand segments 344A and 346A, respectively. But for constraint variant 210B, request simulator 116 determines that the accumulated available capacity, represented by empty segment 312, is not sufficient to satisfy the 110 units of demand segment 342A. Empty segment 316 cannot be accumulated because this segment represents available capacity after the deadline date of August 9^{th} of request 340.

In an embodiment where the request is associated with a high priority, request simulator 116 accumulates any segment having a lower priority. For example, request 340 may be associated with a high priority. In this example, request simulator 116 may accumulate the capacity of empty segment 312 and a portion of low priority load segment 310 to reach the 110 required units represented by demand segment 342A.

In an embodiment, if request simulator 116 determines at least one of constraint variants 210B, 224B, and 232B cannot be satisfied, the request simulator 116 sends a result to a client indicating that the request cannot be confirmed. In contrast, if request simulator 116 determines that all of the constraint variants 210B, 224B, and 232B can be satisfied, then request simulator 116 sends a confirmation of the request.

In an embodiment, by accumulating the availability capacities in parallel, request simulator 116 increases the speed of simulating request 340 within a current supply chain plan. Further, request simulator 116 may quickly determine if any one of constraint variants 210B, 224B, or 232B cannot be satisfied in which case request 340 cannot be satisfied. But, within a supply chain context, one or more constraint variants 342-346 must be satisfied in a specific order. For example, 50 units of constraint variant 232B, represented by demand segment 346A, may need to be produced before 110 units of constraint variant 224B, represented by demand segment 344A, can be produced. Likewise, 110 units of constraint variants 224B may need to be produced before 110 units of constraint variant 210B, represented by demand segment 342A, can be produced. Therefore, though request segment 116 has found a portion of empty segment 326 to satisfy demand segment 344A, demand 342A cannot be satisfied before demand segment 344A is satisfied.

In an embodiment, to address the ordering constraint of the constraint variants 342-346, request simulator 116 sequentially accumulates the availability capacity of each constraint variant in the order specified by the received ordered list of constraint variants. In the example shown in diagram 300B, request simulator 116 first accumulates the available capacity within constraint bar 210C to satisfy demand segment 342B. As described above, request 340 may have a higher priority than that of low-priority load segment 310 in which case a portion of low-priority load segment 310 is accumulated as available capacity.

In an embodiment, upon accumulating enough available capacity to satisfy demand 342B, request simulator 116 attempts to satisfy the next constraint variant, e.g., constraint variant 224B, in the received ordered list. In an embodiment, request simulator 116 accumulates an available capacity of constraint variant 224B from the time at which constraint variant 210B is satisfied towards current time 302. For example, request simulator 116 may accumulate a portion of empty segment 322 to satisfy demand segment 344B. Similarly, request simulator 116 may accumulate empty segment 330 to satisfy demand segment 346B. By sequentially satisfying constraint variants 210B, 224B, and 232B, request simulator 116 addresses the problem noted with respect to diagram 300A.

In an embodiment, request simulator 116 satisfies only a portion of demand segment 346B. In this scenario, request simulator 116 may determine that only a portion of request 340 can be scheduled within the current supply chain plan. In an embodiment, instead of sending a notification to the client indicating that request 340 cannot be scheduled, request simulator 116 sends a notification to the client confirming that a portion of request 340 can be scheduled.

FIG. 4 is a table 400 illustrating various fields 402-412 that enable real-time supply chain response planning, according to an example embodiment. For example, table 400 could represents constraint net-availability table 124 depicted in FIG. 1 that is associated with a constraint variant. In embodiments, table 400 may represent a constraint net-availability table that is queried for constraint variant 210B, which is also represented as constraint bar 304 in FIGS. 3A-B.

In an embodiment, table 400 includes fields: date 402, max capacity 404, and current load 406. Max capacity 404 represents the maximum capacity for constraint variant 210B on a specific date. Current load 406 represents how much of maximum capacity 404 is currently in use on the specific date. Though table 400 specifies various metrics in association with date 402, other measures of time, e.g., hours or weeks, may be used instead of the date.

In an embodiment, to determine whether there is enough available capacity to satisfy demand segment 342B, request simulator 116 queries table 400 to accumulate the available capacity. In an embodiment, to accumulate the available capacity for constraint variant 210B from a deadline 422 on August 9^{th} to a current date 420 of August 1^{st}, request simulator 116 accumulates the difference between max capacity 404 and current load 406. In an embodiment, table 400 includes remaining capacity 408 field, which is the difference between max capacity 404 and current load 406. In an embodiment with table 400 having remaining capacity 408 field, request simulator 116 accumulates remaining capacity 408 from deadline 422 to current date 420. In the example provided in FIG. 3, demand segment 342 represents 110 required units of constraint variant 210B which cannot be satisfied by the accumulated capacity 424 of 100 units. Thus, request simulator 116 may send a result to a client indicating that constraint variant 210B cannot be satisfied.

In an embodiment with constraint variant 210B having loads with different priorities, table 400 includes an additional field, e.g., high-priority load 410 field, for each additional type of priority. As shown in FIGS. 3A-B, constraint bar 304 includes low-priority segment 310. Therefore, high-priority load 410 field indicates a load of 0 on dates August 1^{st}-4^{th}. In an embodiment where the request has high priority, to accumulate the available capacity of constraint variant 210B, request simulator 116 accumulates the difference between max capacity 404 field and high-priority load 410 field. In an embodiment, to further speed up the accumulation, table 400 includes remaining high-priority capacity 412 field that represents a difference between max capacity 404 and high-priority load 410. In this embodiment, request simulator 116 accumulates the entries 426 within remaining high-priority capacity 412 field to determine that the 110 required units of constraint variant 210B can be satisfied.

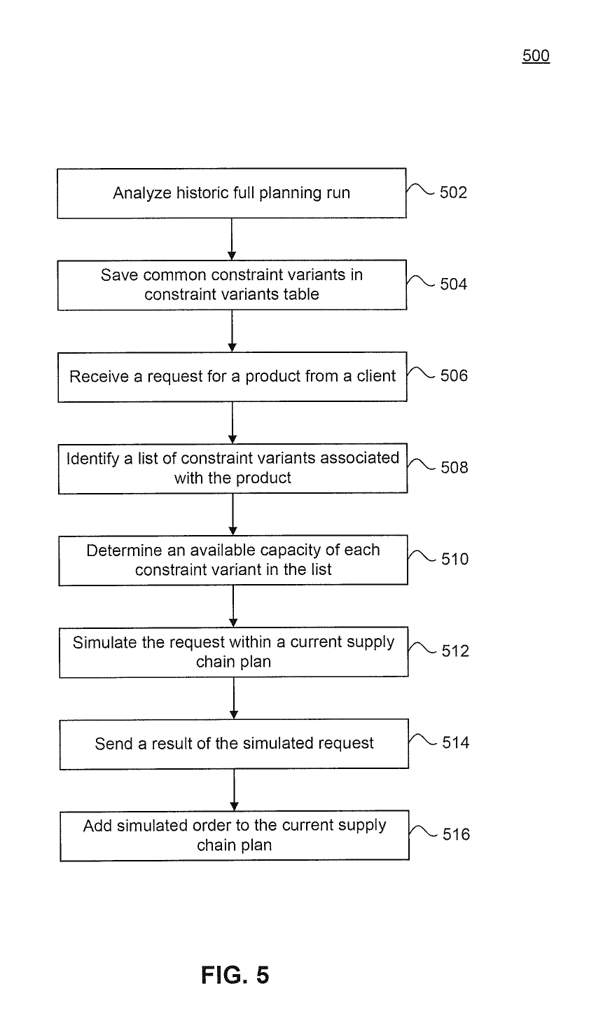

FIG. 5 is a flowchart illustrating a method 500 to provide real-time supply chain response planning, according to an example embodiment. The steps of method 500 may not necessarily be performed in the order specified. Method 500 is discussed with continued reference to FIGS. 1-4. Method 500 can be performed by processing logic that can comprise hardware (e.g., circuitry, dedicated logic, programmable logic, microcode, etc.), software (e.g., instructions run on a processing device), or a combination thereof.

In step 502, a constraint variants analyzer, such as constraint variants analyzer 114 in DBMS 106 of FIG. 1, analyzes one or more previous full-planning runs to determine an ordered list of constraint variants to associate with a product. As described above, a batch-run scheduler, such as batch-run scheduler 112 of FIG. 1, performs the full-planning runs. In an embodiment, the constraint variants analyzer analyzes previous supply chain plans, such as supply chain plan store 126 stored in database storage 108 of FIG. 1, to determine possible sequences of constraint variants. As described with respect to FIG. 2, the constraint variants analyzer aggregates usage numbers of the constraint variants, e.g., a proportion of the previous supply chain plains that used a constraint variant.

In step 504, the constraint variants analyzer saves, within a constraint variants table, the selected ordered list of common constraint variants in association with the product. For example, the constraint variants table may be constraint variants table 122 of FIG. 1. In an embodiment, as shown, the constraint variants analyzer pre-selects and saves an ordered list of constraint variants for each product before performing simulation run for a request involving the product.

In step 506, a request simulator, such as request simulator 116 of FIG. 1, receives a request for a product from a client. In an embodiment, the request includes a deadline to generate the product and one or more constraints of the product. For example, a product constraint may be a brand for a specific part or a type of material for the specific part within the product.

In step 508, the request simulator queries the constraint variants table to identify a list of constraint variants associated with the product indicated in the request. In an embodiment, the identified list is an ordered list of constraint variants that when individually satisfied will satisfy the request.

In step 510, the request simulator determines required capacity of each constraint variant in the ordered list. In an embodiment, the request simulator queries the information stored in the constraint variants table 122 to determine the required capacities.

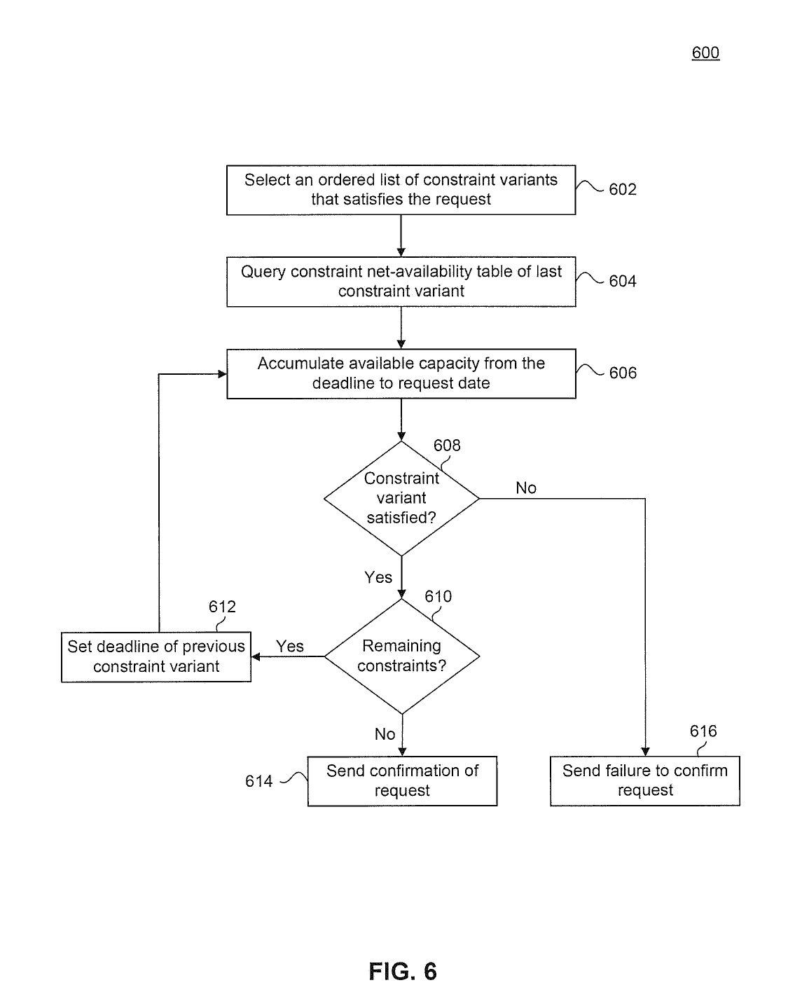

In step 512, the request simulator simulates the request within a current supply chain plan. In general, the simulation may include determining whether each of the constraint variants in step 508 satisfies the associated required capacity determined in step 510. Such simulations are discussed in greater detail with reference to FIGS. 3A-B and 4, above. FIG. 6 below further shows an example embodiment of simulating the request.

In step 514, the request simulator sends a result of the simulated request to the client. If the request could not be successfully simulated in step 512, the result indicates that the request received from the client device of step 506 cannot be successfully scheduled within the current supply chain plan. In contrast, if the request was successfully simulated in step 512, the result confirms that the request of step 506 can be successfully scheduled within the current supply chain plan. In some embodiments, the result confirms a portion of the quantity of the product specified in the request of step 506.

In step 516, the request simulator adds the simulated request to a set of unscheduled requests. In an embodiment, the request simulator adds this simulated request in response to determining that the request was successfully simulated in step 512. In an embodiment, the request simulator receives a confirmation from the user to add the simulated request, which then indicates to the request simulator to add the simulated request.

In an embodiment, the batch-run scheduler subsequently updates the current supply chain plan by scheduling the set of unscheduled requests including the request added in step 516. In an embodiment, the batch-run scheduler updates the current supply chain plan in response to a received command, periodically (e.g., daily), or when the number of unscheduled requests exceed a threshold, or whichever of these events occur first.

FIG. 6 is a flowchart illustrating a method 600 for providing more accurate real-time supply chain response planning, according to an example embodiment. In an embodiment, method 600 shows step 512 in greater detail. The steps of method 600 may not necessarily be performed in the order specified. Additionally, method 600 is discussed with continued reference to FIGS. 1-4. Method 600 can be performed by processing logic that can comprise hardware (e.g., circuitry, dedicated logic, programmable logic, microcode, etc.), software (e.g., instructions run on a processing device), or a combination thereof.

In step 602, a request simulator, such as request simulator 116 from FIG. 1, receives an ordered list of constraint variants that generate a product indicated in a request received from a client. In an embodiment, the request simulator queries a constraint variants table for the ordered list of constraint variants associated with the product.

In step 604, the request simulator queries one or more columns of a constraint net-availability table of the last constraint variant in the ordered list received in step 602. In an embodiment, the last constraint variant refers to a constraint variant that does not have any dependent constraint variants. In an embodiment, the constraint net-availability table is implemented within a column-store database to enable real-time calculations performed on one or more columns of the constraint net-availability table.

In step 606, the request simulator queries one or more columns of the constraint net-availability table for the last constraint variant to accumulate an available capacity of that last constraint variant starting from the deadline to date of the request, i.e., the current date or time.

In step 608, the request simulator determines whether the constraint variant is satisfied. In an embodiment, the request simulator continues to accumulate the available capacity until either the request date is reached or the required capacity is met. If the required capacity is met by the request date, then the constraint variant is satisfied and method 600 proceeds to step 610. Otherwise, the constraint variant is not satisfied and method 600 proceeds to step 616.

In step 616, the request simulator sends a notification to the client indicating a failure to confirm the request. In an embodiment, the request simulator sends a partial confirmation that indicates a portion of the request that was successfully simulated within the current supply chain plan.

In step 610, the request simulator determines whether an immediate-previous constraint variant, from the ordered list, exists. If it exists, the request simulator selects the immediate-previous constraint variant and method 600 proceeds to step 612. Otherwise, no unsatisfied constraint variants remain and method 600 proceeds to step 614.

In step 614, the request simulator sends a continuation that the request can be successfully scheduled within the current supply chain plan. This is because each of the constraint variants within the ordered list of step 602 has been successfully satisfied, i.e., each of the associated required capacities has been met.

In step 612, the request simulator sets the deadline of the immediate-previous constraint variant determined in step 610. In particular, the request simulator sets the deadline to be the date determined in step 608 from which the subsequent constraint-variant is satisfied. Then, method 600 returns to step 606 where the request simulator accumulates the available capacity of the immediate-previous constraint variant from the new deadline to the request date.

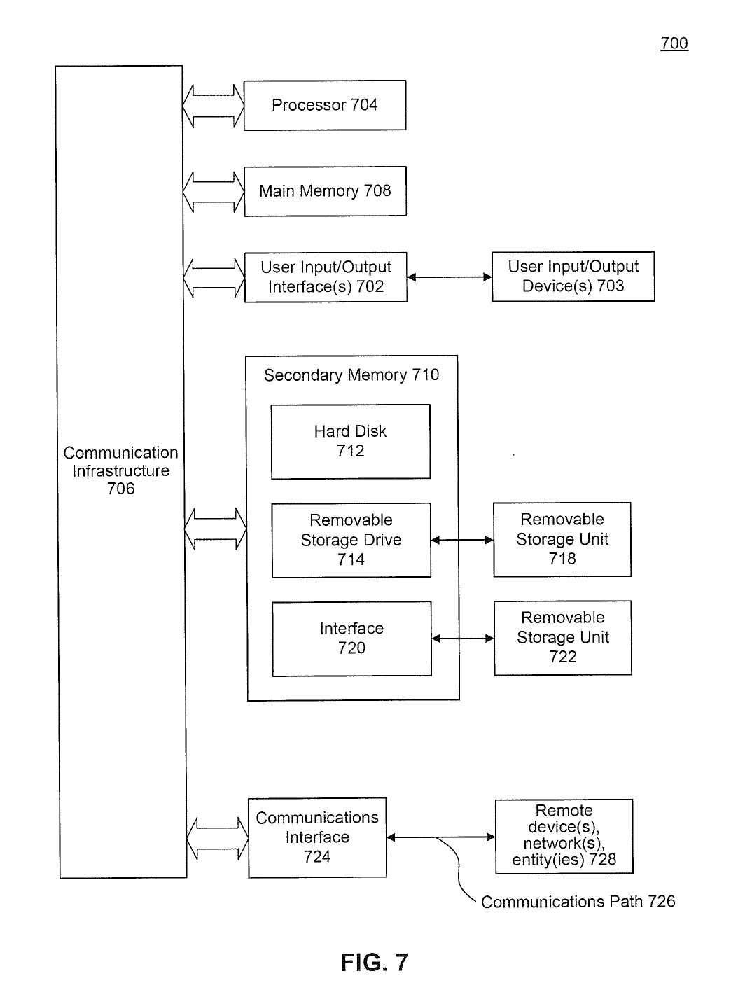

Various embodiments can be implemented, for example, using one or more well-known computer systems, such as computer system 700 shown in FIG. 7. Computer system 700 can be any well-known computer capable of performing the functions described herein.

Computer system 700 includes one or more processors (also called central processing units, or CPUs), such as a processor 704. Processor 704 is connected to a communication infrastructure or bus 706.

One or more processors 704 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 also includes user input/output device(s) 703, such as monitors, keyboards, pointing devices, etc., that communicate with communication infrastructure 706 through user input/output interface(s) 702.

Computer system 700 also includes a main or primary memory 708, such as random access memory (RAM). Main memory 708 may include one or more levels of cache. Main memory 708 has stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 reads from and/or writes to removable storage unit 718 in a well-known manner.

According to an exemplary embodiment, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and which may include any combination of LANs, WANs, the Internet, etc. Control logic and/or data may be transmitted to and from computer system 700 via communication path 726.

In an embodiment, a tangible apparatus or article of manufacture comprising a tangible computer useable or readable medium having control logic (software) stored thereon is also referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of the invention using data processing devices, computer systems and/or computer architectures other than that shown in FIG. 7. In particular, embodiments may operate with software, hardware, and/or operating system implementations other than those described herein.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A method, comprising:
receiving a request from a client device specifying a quantity of a product to be scheduled within a current supply chain plan, wherein the request includes a deadline;
identifying, from a constraint variants table, a list of constraint variants associated with the product, wherein each constraint variant in the list is associated with a net-availability table stored in a column-store in-memory database;
determining, based on the constraint variants table, a required capacity for each constraint variant in the list to satisfy the request;
simulating the request within the current supply chain plan by aggregating an available capacity for each constraint variant, using one or more columns of the associated net-availability table, to determine whether the required capacity is satisfied for each constraint variant; and
transmitting a result indicating whether the request can be successfully scheduled based on the simulated request to the client device,
wherein at least one of the receiving, identifying, determining, simulating, and sending are performed by one or more computers.

2. The method of claim 1, wherein the required capacity is representative of a plurality of constraints.

3. The method of claim 1, further comprising:
analyzing one or more previously-simulated supply chain plans to determine a plurality of ordered lists of constraint variants associated with producing the product;
selecting an ordered list from the plurality of ordered lists; and
saving the selected ordered list within the constraint variants table, wherein the ordered list includes most commonly scheduled constraint variants within the one or more previously-simulated supply chain plans, and wherein the saved ordered list is the identified list of constraint variants.

4. The method of claim 1, further comprising:
in response to sending the result, receiving a confirmation, from the client device, to schedule the request; and
adding the simulated request to a set of requests that is scheduled in the supply chain plan in a next iteration of a batch run.

5. The method of claim 1, further comprising:
determining that an available capacity for a constraint variant, from the list, is less than a corresponding required capacity; and
transmitting an indication that the request cannot be satisfied within the current supply chain plan to the client device.

6. The method of claim 1, wherein the net-availability table comprises one or more of: a dates column, a maximum capacity column, and a current load column.

7. The method of claim 6, wherein the simulating comprises:
aggregating the available capacity by aggregating a difference between entries in the maximum capacity column and the current load column from a deadline date towards a current date.

8. A system, comprising:
a column-store in-memory database; and
at least one processor coupled to the column-store in-memory database and configured to:
receive a request from a client device specifying a quantity of a product to be scheduled within a current supply chain plan, wherein the request includes a deadline;
identify, from a constraint variants table, a list of constraint variants associated with the product, wherein each constraint variant in the list is associated with a net-availability table stored in a column-store in-memory database;
determine, based on the constraint variants table, a required capacity for each constraint variant in the list to satisfy the request;
simulate the request within the current supply chain plan by aggregating an available capacity for each constraint variant, using one or more columns of the associated net-availability table, to determine whether the required capacity is satisfied for each constraint variant; and
transmit a result indicating whether the request can be successfully scheduled based on the simulated request to the client device.

9. The system of claim 8, wherein the required capacity is representative of a plurality of constraints.

10. The system of claim 8, wherein the at least one processor is further configured to:
analyze one or more previously-simulated supply chain plans to determine a plurality of ordered lists of constraint variants associated with producing the product;
select an ordered list from the plurality of ordered lists; and
save the selected ordered list within the constraint variants table, wherein the ordered list includes most commonly scheduled constraint variants within the one or more previously-simulated supply chain plans, and wherein the saved ordered list is the identified list of constraint variants.

11. The system of claim 8, wherein the at least one processor is further configured to:
in response to sending the result, receive a confirmation, from the client device, to schedule the request; and
add the simulated request to a set of requests that is scheduled in the supply chain plan in a next iteration of a batch run.

12. The system of claim 8, wherein the at least one processor is further configured to:
determine that an available capacity for a constraint variant, from the list, is less than a corresponding required capacity; and
transmit an indication that the request cannot be satisfied within the current supply chain plan to the client device.

13. The system of claim 8, wherein the net-availability table comprises one or more of: a dates column, a maximum capacity column, and a current load column.

14. The system of claim 13, the at least one processor is further configured to simulate the request by:
aggregating the available capacity by aggregating a difference between entries in the maximum capacity column and the current load column from a deadline date towards a current date.

15. A non-transitory computer-readable device having instructions stored thereon that, when executed by at least one computing device, causes the at least one computing device to perform operations comprising:
receiving a request from a client device specifying a quantity of a product to be scheduled within a current supply chain plan, wherein the request includes a deadline;
identifying, from a constraint variants table, a list of constraint variants associated with the product, wherein each constraint variant in the list is associated with a net-availability table stored in a column-store in-memory database;
determining, based on the constraint variants table, a required capacity for each constraint variant in the list to satisfy the request;
simulating the request within the current supply chain plan by aggregating an available capacity for each constraint variant, using one or more columns of the associated net-availability table, to determine whether the required capacity is satisfied for each constraint variant; and
transmitting a result indicating whether the request can be successfully scheduled based on the simulated request to the client device,
wherein at least one of the receiving, identifying, determining, simulating, and sending are performed by one or more computers.

16. The computer-readable device of claim 15, the operations further comprising:
analyzing one or more previously-simulated supply chain plans to determine a plurality of ordered lists of constraint variants associated with producing the product;
selecting an ordered list from the plurality of ordered lists; and
saving the selected ordered list within the constraint variants table, wherein the ordered list includes most commonly scheduled constraint variants within the one or more previously-simulated supply chain plans, and wherein the saved ordered list is the identified list of constraint variants.

17. The computer-readable device of claim 15, the operations further comprising:
in response to sending the result, receiving a confirmation, from the client device, to schedule the request; and
adding the simulated request to a set of requests that is scheduled in the supply chain plan in a next iteration of a batch run.

18. The computer-readable device of claim 15, the operations further comprising:
determining that an available capacity for a constraint variant, from the list, is less than a corresponding required capacity; and
transmitting an indication that the request cannot be satisfied within the current supply chain plan to the client device.

19. The computer-readable device of claim 15, wherein the net-availability table comprises one or more of: a dates column, a maximum capacity column, and a current load column.

20. The computer-readable device of claim 19, the operations further comprising:
aggregating the available capacity by aggregating a difference between entries in the maximum capacity column and the current load column from a deadline date towards a current date.
